(19) United States
(12) Patent Application Publication
(10) Pub. No.: US 2006/0267353 A1
(43) Pub. Date: Nov. 30, 2006

(54) Doorstop

(76) Inventor: Cristiaan Stefanus Lambertus Petrus Van Den Heuvel, Penetanguishene (CA)

Correspondence Address: Michael R. Friscia;McCarter & English, LLP, Four Gateway Center, 100 Mulberry Street, Newark, NJ, 07102, US

(21) Appl. No.: 11/141,684

(22) Filed: May 31, 2005

(51) Int. Cl. E05C 17/04

(52) U.S. Cl. 292/262

(57) ABSTRACT

A doorstop with at least three cushions on its upper surface. Two male protrusions extend from the lower surface to facilitate assembly to a vehicle.

### SUMMARY OF THE INVENTION

According to the invention there is provided a doorstop having at least three cushions on an upper surface thereof and at least two male protrusions extending in a direction away from said cushions and spaced apart in a direction along a longitudinal axis of said doorstop.

In one embodiment there is provided a doorstop comprising two housing parts each of approximately trapezium shape and each having three cushions on the upper surface thereof and a threaded male protrusion extending in a direction away from said bumpers on said respective housing part and spaced in a direction away from said cushions on said respective housing part and spaced in a direction along a longitudinal axis of the housing part from said bumpers.

### DESCRIPTION OF THE DRAWINGS

Embodiments of the invention will now be described, by way of example, with reference to the accompanying drawings in which:

FIG. 1 shows a doorstop from U.S. Pat. No. 6,842,943 in a sectional side view;

FIG. 2 is a plan view of a doorstop according to one embodiment of the present invention;

FIG. 3 is a perspective view of the two parts forming the doorstop of FIG. 2 opened up for clarity purposes.

FIG. 4 is another view of the two parts forming the doorstop of FIG. 2 opened up for clarity purposes.

FIG. 5 is a perspective view of a doorstop of approximately rectangular cross-section;

FIGS. 6 and 7 illustrate other parts for use with the doorstop part of FIG. 5;

FIGS. 8 and 9 illustrate a further embodiment of the invention; and

FIGS. 10 and 11 illustrate a yet further embodiment.

### DETAILED DESCRIPTION

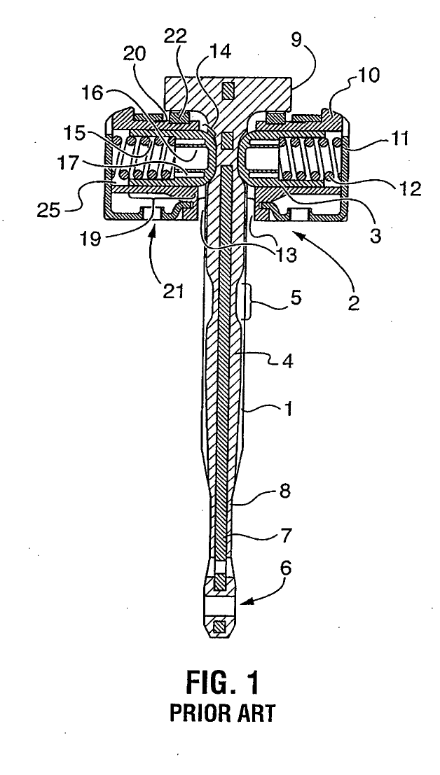

FIG. 1 shows a sectional side view of a doorstop, as illustrated in U.S. Pat. No. 6,842,943, the plane of section running through the doorstop parallel to the pivot axis and the door retaining rod 1 passing though the retaining piece 2. At its bottom end in the figure, the door-retaining rod 1 has a bearing eye 6 and at the other end an abutment 9. The door-retaining rod 1 is constructed from a metal core 7, for example a flat steel section, which is covered with plastic. The plastic covering 8 is applied with different thicknesses over the length and forms bulges in the form of local thickenings, which form the brake ramps 4 and the catch depressions 5 between the bulges. In the exemplary embodiment shown, the abutment 9, which forms the limit stop corresponding to the open position of the door, is of integral T-shaped design. The abutment 9 or the limit stop may also be alternatively formed by a pin, which is arranged through a corresponding opening in the door retaining rod 1 in the direction of the pivot axis. The brake ramps 4 and the catch depressions 5 are formed on the sides of the door-retaining rod facing the pivot axis. In the position shown the brake and/or stop bodies 3 bear bilaterally preloaded against catch depressions. The door-retaining rod 1 is led through the opening 13 in the housing 10. The brake and/or stop bodies 3 are guided in guide openings 25 arranged perpendicular to the opening 13.

The brake and/or stop bodies 3 take the form of hollow cylinders, which are sealed at one end by a semi-spherical cap 14. In their open end they accommodate a pressure spring 12 resting on the closing cap 14, the spring being supported on a side wall of the housing 10. The end faces of the housing 10 are enclosed by U-shaped metal frames 11, which also constitute the supporting wall for the pressure springs. The brake and/or stop bodies 3 have a central bore 16 accessible from their cylindrical cavity 15 and further bores 17 arranged in a circle around this. The shape and arrangement of the bores 16 and 17 permit approximately equal wall thicknesses in the semi-spherical cap 14. The semi-spherical cap 14 is truncated at its front end. The approximately equal wall thicknesses provide an advantageous prerequisite for manufacturing the brake and/or stop bodies from plastic by the injection molding process. In its cylindrical part 19 the outer wall of the brake and/or stop bodies 3 is fluted in the direction of movement, thereby on the one hand ensuring a favorable distribution and transmission of slide lubricants and on the other reducing the bearing surface of the cylindrical part 19 on the inner surface of the guide opening 25 and hence frictional forces occurring when the brake and/or stop bodies 3 slide in the guide opening 25.

Cushions 22 of an elastic material are integrated into the upper end surface 20 of the housing 10, against which cushions the abutment 9 resiliently strikes when the door is in the open position. Fixing apertures 21 are arranged in the bottom end surfaces of the metal frames 11. In the exemplary embodiment shown these have an internal thread for fixing the retainer piece to a door assembly piece by means of threaded screws. Press-on screws, not shown here, can also be used for fixing, however. It will be obvious that in the embodiment of the housing 10 and metal frame 11 shown there is a high degree of flexibility in the choice of hole spacing and hence in the hole piercing variants.

The present invention is concerned with a doorstop, or door closure housing, which offers advantages over that shown in the above-identified U.S. patent.

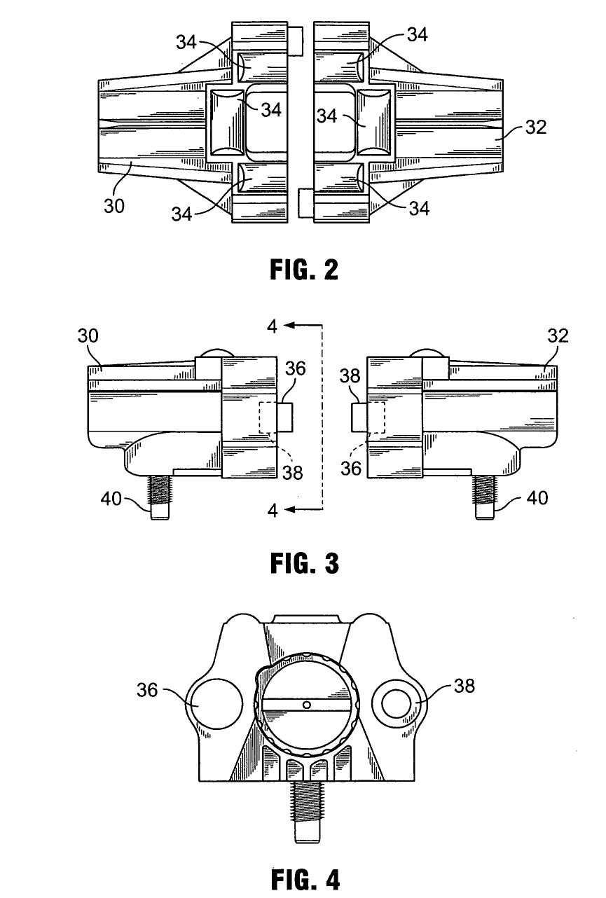

Referring to FIGS. 2, 3 and 4, the doorstop is made of two similar housing parts 30 and 32 of approximately trapezium shape in cross-section. A total of six stop cushions 34 of elastic material are integrated into the upper surfaces of the housing parts 30 and 32, three on each plastic housing part. This number of cushions 34 is a substantial non-obvious improvement over previous arrangements and permits the accommodation of more “head” configurations than previously accomplished. Even only a total of four cushions 34 were found to be advantageous, although six were better. It is a cost saving as well, over putting the cushions on a link arm.

The two housing parts fit together with an aligning or “locking” mechanism comprising two round male/female bushings 36 and 38. It has been found that this tends to overcome a matching and stacking problem.

A male threaded stud 40 is provided on each housing part 30 and 32 to facilitate assembly to a vehicle by a customer.

The parts of the housing can conveniently be produced by using a sonic welding procedure. This would appear to result in a saving of costs for two rivets and should save integrity and time.

It will be understood that the frame in the housing according to the present invention is all plastic whereas in the above-identified U.S. patent the frame 11 is a U-shaped metal frame.

In some arrangements the housing parts may be offset.

It will be understood that injection moulding may be utilised and the parts may be run on vertical or horizontal machines. It is anticipated that multi-cavity molds may be used. Shrink and warp behaviour in insert moulding due to the size of the product is expected. Control of the process characteristics, such as mold temperatures, injection speeds and pressure is required. Proper drying of the material is required. Co-injection and/or over moulding can also be used to manufacture the product.

It will be also understood that, the fabrication technology used may be suitable for the formation of large, long-fibre-reinforced structural thermoplastic parts.

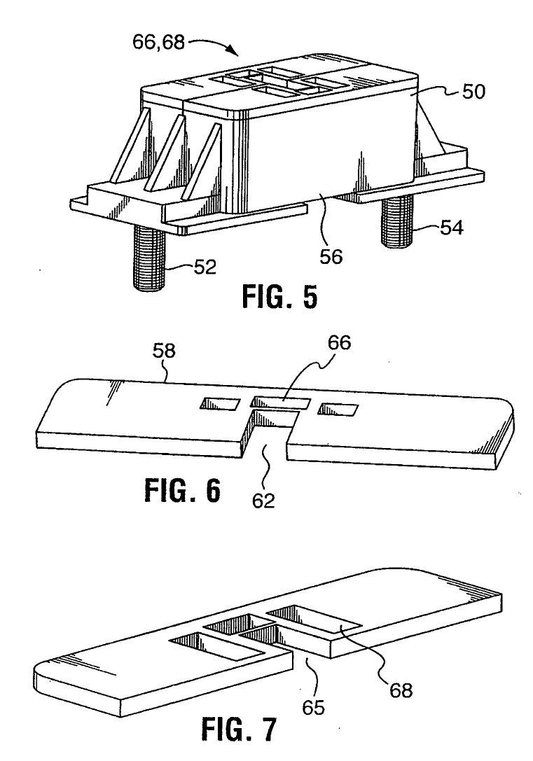

Another embodiment of the present invention is shown in FIGS. 5-7. In FIG. 5 it will be seen that the doorstop 50 is of rectangular shape in cross-section and has two studs 52 and 54 in an appropriate location. As will be appreciated studs 52 and 54 may be threaded or un-threaded. These studs are moulded in the base of doorstop 50 which has a central aperture 56 where by a link arm assembly can be inserted.

To close the top of doorstop 50 two panels 66 and 68 (FIGS. 6 and 7) are used. These are each of a dimension to cover half the top of doorstop 50 and close the top apart from rectangular apertures 62 and 64. The two half panels 66 and 68 are moulded with cushions, i.e. bumpers, and when completed by either heat or electrosonic “staking” will form an enclosed top as in FIG. 5.

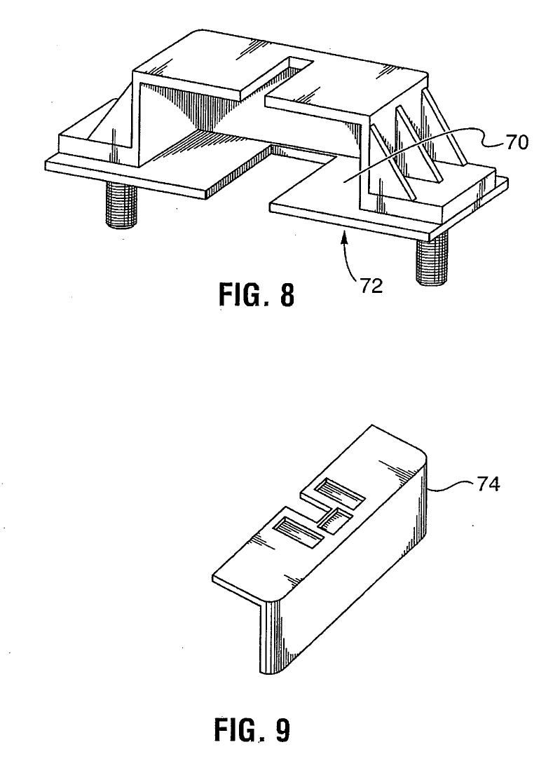

FIG. 8 illustrates a further embodiment in which the side 70 of the rectangular doorstop 72 is open. Again two studs are moulded into place.

The side is closed by a right-angle shaped moulded plastic part, as in FIG. 9, with over moulded soft rubber “bumpers” on the sides of the angle-shaped plastic parts. It is assembled by means of either heat staking or ultra-sonic welding to the rectanguloid part 72.

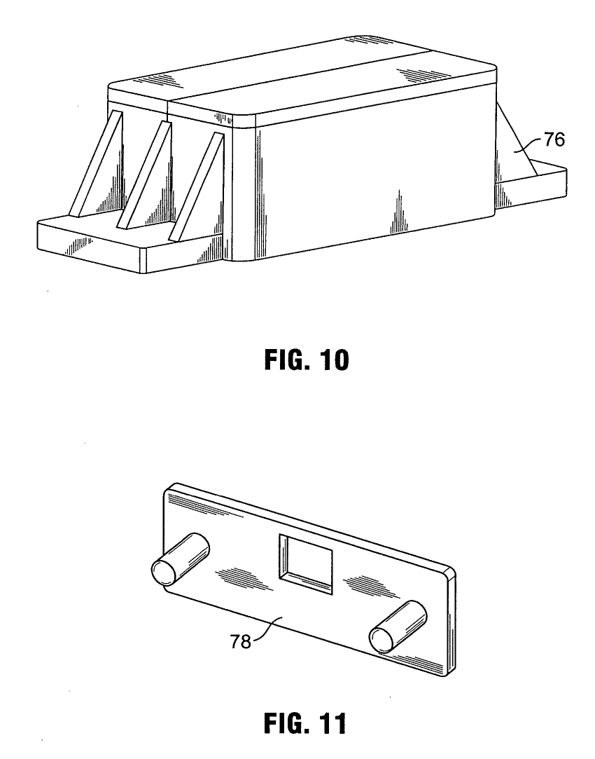

In a yet further embodiment the rectanguloid plastic part 76, in FIG. 10, is moulded with a rectangular cushion or bumper made of a rubber-like material. The bottom or base is open and a moulded plastic plate 78 (FIG. 11) with two studs is joined to part 76 by means of either heat staking or ultrasonic welding.

Having thus described the invention in detail, it is to be understood that the foregoing description is not intended to limit the spirit and scope thereof. What is desired to be protected by Letters Patent is set forth in the appended claims.

1. A doorstop having comprising at least three cushions on an upper surface thereof and at least two male protrusions extending in a direction away from said cushions and spaced apart in a direction along a longitudinal axis of said doorstop.

2. The doorstop of claim 1, further comprising two housing parts of approximately trapezium shape.

3. The doorstop of claim 2, wherein the two housing parts fit together with an aligning mechanism comprising two male/female bushings.

4. The doorstop of claim 1, wherein the doorstop has a central aperture with six cushions positioned therearound.

5. The doorstop of claim 2, wherein the doorstop has a central aperture with six cushions positioned therearound.

6. The doorstop of claim 3, wherein the doorstop has a central aperture with six cushions positioned therearound.

7. The doorstop of claim 1, wherein the two male protrusions are threaded.

8. The doorstop of claim 2, wherein the two male protrusions are threaded.

9. The doorstop of claim 3, wherein the two male protrusions are threaded.

10. The doorstop of claim 4, wherein the two male protrusions are threaded.

11. The doorstop of claim 5, wherein the two male protrusions are threaded.

12. The doorstop of claim 6, wherein the two male protrusions are threaded.

13. The doorstop of claim 1, wherein the doorstop is formed using a sonic weld process.

14. The doorstop of claim 1, wherein the doorstop is rectangular shape in cross-section with at least three cushions on an upper surface thereof with two male protrusions extending in a direction away from said cushions and spaced apart in a direction along a longitudinal axis of said doorstop.

15. The doorstop of claim 14, further comprising six cushions spaced apart on the upper surface of the doorstop.

16. The doorstop of claim 14, wherein a top of the doorstop is closed by two half panels having said cushions thereon.

17. The doorstop of claim 15, wherein a top of the doorstop is closed by two half panels having said cushions thereon.

18. The doorstop of claim 14, wherein a side of the doorstop is open and is closed by a right-angled shaped molded plastic part.

19. The doorstop of claim 15, wherein a side of the doorstop is open and is closed by a right-angled shaped molded plastic part.

20. The doorstop of claim 16, wherein a side of the doorstop is open and is closed by a right-angled shaped molded plastic part.

21. The doorstop of claim 17, wherein a side of the doorstop is open and is closed by a right-angled shaped molded plastic part.

22. The doorstop of claim 14, wherein the doorstop is molded with a rectangular cushion of rubber-like material, and has an open base which is closed by a molded plastic plate having said two male protrusions thereon.
